(19) United States
(12) Patent Application Publication
(10) Pub. No.: US 2015/0174740 A1
(43) Pub. Date: Jun. 25, 2015

(54) ELASTIC RETAINING ASSEMBLY AND METHOD

(71) Applicant: GM GLOBAL TECHNOLOGY OPERATIONS LLC, DETROIT, MI (US)

(72) Inventors: Steven E. Morris, Fair Haven, MI (US); Jennifer P. Lawall, Waterford, MI (US)

(73) Assignee: GM GLOBAL TECHNOLOGY OPERATIONS LLC, DETROIT, MI (US)

(21) Appl. No.: 14/134,888

(22) Filed: Dec. 19, 2013

(51) Int. Cl. B25B 11/02

(52) U.S. Cl. CPC B25B 11/02

(57) ABSTRACT

An elastic retaining assembly includes a first component having a first surface, a second component having first and second surfaces, and a receiving feature extending through the second component, the receiving feature defining a wall. Also included is a protrusion operatively coupled to, and extending away from, the first surface, wherein the protrusion is formed of an elastically deformable material and configured to elastically deform upon contact with a wall of the receiving feature, wherein the protrusion retains the first component to the second component in a first direction. Further included is a retention member located at a first end of the protrusion and extending radially from the first end of the protrusion, the retention member configured to abut the second surface of the second component and be rotated to retain the first component to the second component in a second direction that is substantially perpendicular to the first direction.

### FIELD OF THE INVENTION

The present invention relates to matable components, and more particularly to an elastic retaining assembly for such matable components, as well as a method of assembling matable components.

### BACKGROUND

Currently, components which are to be mated together in a manufacturing process are subject to positional variation based on the mating arrangements between the components. One common arrangement includes components mutually located with respect to each other by 2-way and/or 4-way male alignment features; typically undersized structures which are received into corresponding oversized female alignment features such as apertures in the form of openings and/or slots. Alternatively, double-sided tape, adhesives or welding processes may be employed to mate parts. Irrespective of the precise mating arrangement, there is a clearance between at least a portion of the alignment features which is predetermined to match anticipated size and positional variation tolerances of the mating features as a result of manufacturing (or fabrication) variances. As a result, occurrence of significant positional variations between the mated components is possible, which may contribute to the presence of undesirably large and varying gaps. The clearance between the aligning and attaching features may lead to relative motion between mated components, which contribute to poor perceived quality. Additional undesirable effects may include squeaking and rattling of the mated components, for example.

### SUMMARY OF THE INVENTION

In an exemplary embodiment, an elastic retaining assembly for matable components includes a first component having a first surface. Also included is a second component having a first surface and a second surface, the second component configured to be mated with the first component in a fully engaged position. Further included is a receiving feature extending through the second component, the receiving feature defining a wall. Yet further included is a protrusion operatively coupled to, and extending away from, the first surface, wherein the protrusion is formed of an elastically deformable material and configured to elastically deform upon contact with the wall of the receiving feature, wherein the protrusion retains the first component to the second component in a first direction in the fully engaged position. Also included is a retention member located at a first end of the protrusion and extending radially from the first end of the protrusion, the retention member formed of the elastically deformable material, wherein the retention member is configured to abut the second surface of the second component and be rotated to retain the first component to the second component in a second direction that is substantially perpendicular to the first direction in the fully engaged position.

In another exemplary embodiment, a method of assembling matable components is provided. The method includes inserting an elastically deformable protrusion of a first component into a receiving feature of a second component, wherein a contact interference condition between the elastically deformable protrusion and a wall of the receiving feature retains the elastically deformable protrusion in a first direction. The method also includes elastically deforming the elastically deformable protrusion upon contacting the wall of the receiving feature. The method further includes rotating the elastically deformable protrusion with a first wing portion extending radially away from a central axis of the elastically deformable protrusion and a second wing portion extending radially away from the central axis in a first radial direction, wherein the second wing portion is angled about 180 degrees from the first radial direction. The method yet further includes retaining the first component to the second component in a second direction that is substantially perpendicular to the first direction upon rotating the elastically deformable protrusion into a fully engaged position.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective, partial cross-sectional view of an elastic retaining assembly having a first component and a second component;

FIG. 2 is a top view of the second component according to an embodiment;

FIG. 3 is a side view of a ramp of the second component;

FIG. 4 is a top view of a retention member disposed in a non-engaged position relative to a top surface of the second component;

FIG. 5 is a side view of the retention member in a non-engaged position;

FIG. 6 is a side view of the retention member in a partially engaged position;

FIG. 7 is a top view of the retention member in a fully engaged position;

FIG. 8 is a side view of the retention member in a partially engaged position with the second component according to another embodiment;

FIG. 9 is a side view of the retention member in a fully engaged position with the second component of the embodiment of FIG. 8; and

FIG. 10 is a flow diagram illustrating a method of assembling matable components with the elastic retaining assembly.

### DESCRIPTION OF THE EMBODIMENTS

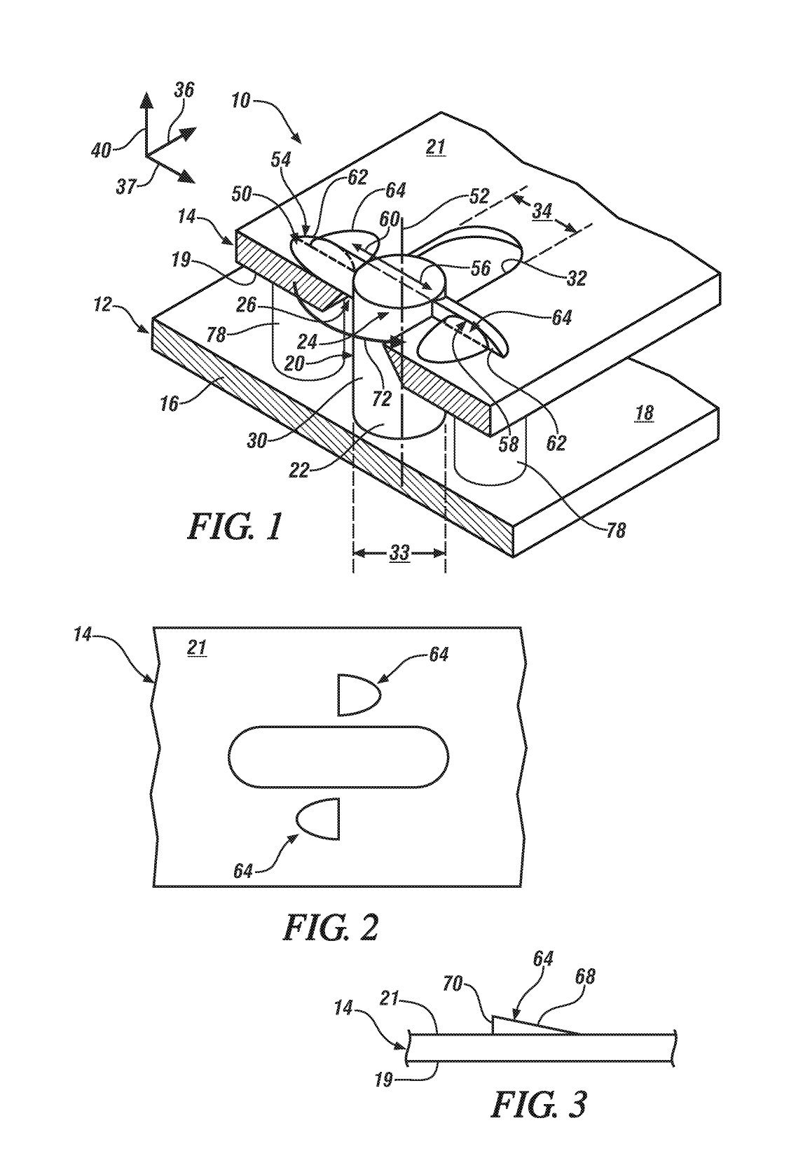

Referring to FIG. 1, an elastic retaining assembly 10 is illustrated. The elastic retaining assembly 10 comprises matable components, such as a first component 12 and a second component 14 that are configured to be mated and aligned with respect to each other. In one embodiment, the elastic retaining assembly 10 is employed in a vehicle application. However, it is to be understood that the components may be associated with numerous other applications and industries, such as home appliance and aerospace applications, for example. In an exemplary embodiment such as the aforementioned vehicle application, the first component 12 comprises an automotive interior trim garnish component and the second component 14 comprises a panel for mounting the trim garnish thereto.

Although illustrated in a specific geometry, the first component 12 and the second component 14 may be configured in countless geometries. Regardless of the precise geometry of the first component 12 and the second component 14, the first component 12 is configured to align and fittingly mate with the second component 14, which will be described in detail below. In an alternative embodiment, rather than two components comprising the elastic retaining assembly 10, additional or intermediate layers or components may be included. It is to be appreciated that the elastic retaining assembly 10 is to be employed for providing a self-aligning relationship between components, such as the first component 12 and the second component 14, to each other, while also assisting in securely mating the components to each other.

The first component 12 includes a main portion 16 having a first surface 18 that is typically a substantially planar surface. In the illustrated embodiment, the first surface 18 is to be disposed in close proximity to a first surface 19 of the second component 14 when the components are mated in a fully engaged position. The second component 14 also includes a second surface 21. The first component 12 also includes a protrusion 20 extending from the main portion 16 in a direction relatively orthogonal from a plane that the first surface 18 is disposed in. The protrusion 20 is operatively coupled to the main portion 16 and may be integrally formed with the main portion 16. The protrusion 20 includes a main body 22 extending from the first surface 18 to a second end 24. The second component 14 includes a receiving feature 26 in the form of a cutout slot portion that is configured to engage and receive the protrusion 20 upon mating of the first component 12 and the second component 14. Specifically, the protrusion 20 is inserted into the receiving feature 26 in a direction 40. Although a single protrusion and a single receiving feature are referenced, embodiments of the elastic retaining assembly 10 may include a plurality of protrusions and a plurality of receiving features, as will be described in detail below.

The protrusion 20 and the receiving feature 26 may be formed as numerous contemplated complimentary embodiments. In the exemplary embodiment, the main body 22 of the protrusion 20 is formed as a relatively tubular member and it is to be appreciated that the main body 22 may comprise a solid cylindrical member or a tubular member having a hollow portion. Further, numerous alternative geometries may form the main body 22 of the protrusion.

As will be apparent from the description herein, the elastically deformable nature of the protrusions, in combination with the particular orientations described above, facilitates precise alignment of the first component 12 relative to the second component 14 by accounting for positional variation of the retaining and/or locating features of the first component 12 and the second component 14 inherently present due to manufacturing processes. The self-aligning benefits associated with the elastic retaining assembly 10 will be described in detail below.

The main body 22 of the protrusion 20 of the first component 12 is positioned and engaged with the receiving feature 26 of the second component 14 upon translation of the first component 12 toward the second component 14 (or vice versa). More particularly, a protrusion perimeter surface 30 of the main body 22 engages an aperture wall 32. Subsequent translation results in an elastic deformation of the main body 22. Specifically, the main body 22 includes a protrusion width 33 that is greater than an aperture width 34, thereby ensuring contact between the protrusion perimeter surface 30 and the aperture wall 32 of the receiving feature 26. Elastic deformation of the main body 22 may be further facilitated by embodiments comprising a hollow protrusion, as illustrated. The void of material proximate the hollow portion enhances the flexibility of the protrusion 20. Regardless of whether the protrusion 20 is solid or hollow, the main body 22 is further translated along the aperture wall 32.

Any suitable elastically deformable material may be used to construct the protrusion 20. The term “elastically deformable” refers to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Numerous examples of materials that may at least partially form the components include various metals, polymers, ceramics, inorganic materials or glasses, or composites of any of the aforementioned materials, or any other combinations thereof. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. An example of a suitable polymer includes acetal (e.g., POM). In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS), such as an ABS acrylic. The material may be in any form and formed or manufactured by any suitable process, including stamped or formed metal, composite or other sheets, forgings, extruded parts, pressed parts, castings, or molded parts and the like, to include the deformable features described herein. The material, or materials, may be selected to provide a predetermined elastic response characteristic of the protrusion 20. The predetermined elastic response characteristic may include, for example, a predetermined elastic modulus and/or coefficient of friction.

The precise position where engagement between the protrusion perimeter surface 30 and the aperture wall 32 of the receiving feature 26 occurs will vary depending on positional variance imposed by manufacturing factors. Due to the elastically deformable properties of the elastic material comprising the protrusion 20, the criticality of the initial location of engagement is reduced. Further insertion of the main body 22 into the receiving feature 26 ultimately leads to a fully engaged position of the main body 22. In the fully engaged position, a tight, fitted engagement between the main body 22 and the receiving feature 26 is achieved by contact interface between the protrusion perimeter surface 30 and the aperture wall 32. Such a condition is ensured by sizing the protrusion perimeter, width or other dimension to be larger than a retaining feature dimension (e.g., width). In the fully engaged position, the protrusion 20 retains the first component 12 to the second component 14 in a first direction 37.

The interference between the main body 22 and the aperture wall 32 causes elastic deformation proximate protrusion perimeter surface 30. The malleability of the materials reduces issues associated with positional variance. More particularly, in contrast to a rigid insert that typically results in gaps between the insert and receiving structure at portions around the perimeter of the insert, the main body 22 advantageously deforms to maintain alignment of the first component 12 and the second component 14, while also reducing or eliminating gaps associated with manufacturing challenges. The assembly also advantageously reduces the number of mechanical fasteners, such as threaded fasteners required for attachment of the components, thereby reducing cost and component degradation.

The first component 12 may include a plurality of protrusions 20, while the second component 14 may include a plurality of receiving features 26. The plurality of receiving features is positioned to correspondingly receive respective protrusions in a manner described in detail above. The elastic deformation of the plurality of protrusions elastically averages any positional errors of the first component 12 and the second component 14. In other words, gaps that would otherwise be present due to positional errors associated with portions or segments of the first component 12 and the second component 14, particularly locating and retaining features, are eliminated by offsetting the gaps with an over-constrained condition of other elastically deformable protrusions. Specifically, the positional variance of each protrusion and/or receiving feature is offset by the remaining protrusions to average in aggregate the positional variance of each protrusion.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. In some embodiments, the elastically deformable component configured to have the at least one feature and associated mating feature disclosed herein may require more than one of such features, depending on the requirements of a particular embodiment. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, now U.S. Publication No. U.S. 2013-0019455, the disclosure of which is incorporated by reference herein in its entirety. The embodiments disclosed above provide the ability to convert an existing component that is not compatible with the above-described elastic averaging principles, or that would be further aided with the inclusion of an elastically averaged alignment and retention system as herein disclosed, to an assembly that does facilitate elastic averaging and the benefits associated therewith.

With continued reference to FIG. 1, in addition to retaining the first component 12 relative to the second component 14 in the first direction 37 in the fully engaged position, the first component 12 is retained relative to the second component 14 in a second direction 40. As shown, the second direction 40 is substantially perpendicular to the first direction 37. Retaining in the second direction 40 is achieved with a retention member 50 that is operatively coupled to the protrusion 20 and with deformation of wall 30. The retention member 50 is located at the second end 24 of the protrusion 20. In other words, the retention member 50 is located at an end of the main body 22 of the protrusion 20, relative to the first surface 18 of the first component 12 that the protrusion 20 extends from. The retention member 50 may be integrally formed with the main body 22 or may be coupled to the main body 22 in a manner that allows the retention member 50 to be rotatable relative to the main body 22. As is the case with the main body 22, the retention member 50 is typically formed of an elastically deformable material that is similar or identical to the material employed for the main body 22.

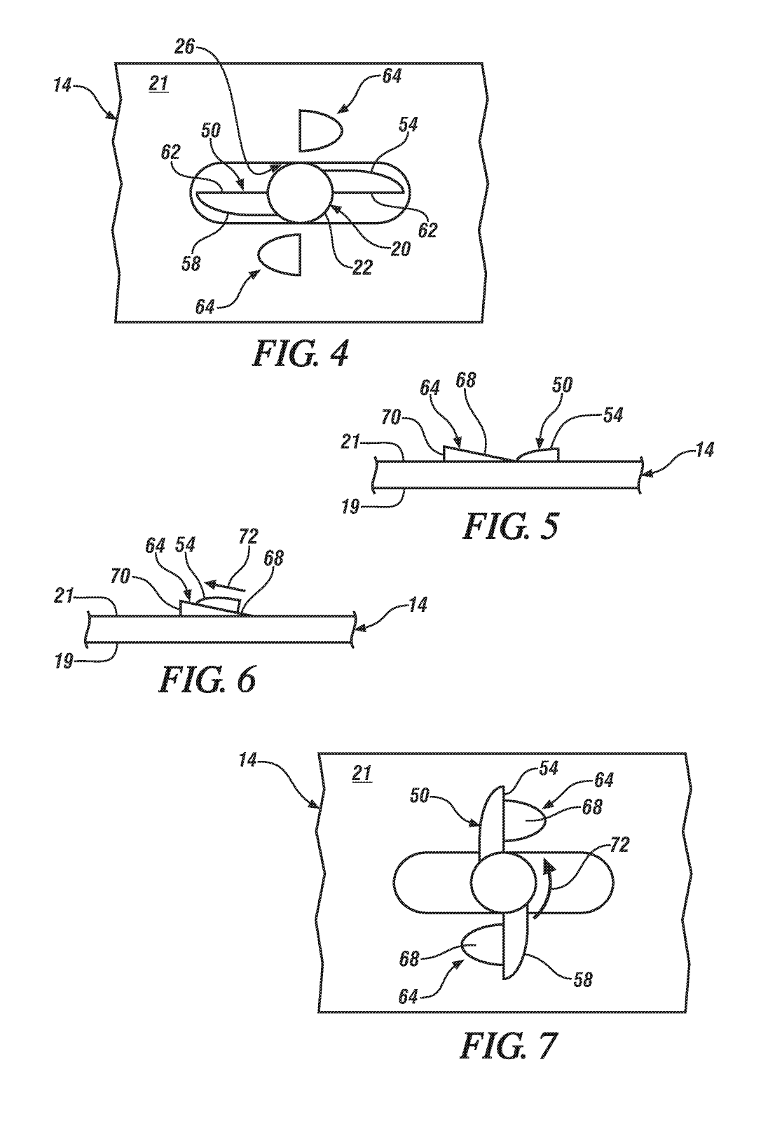

The retention member 50 extends radially from a central axis 52 of the main body 22 of the protrusion 20. In particular, the retention member 50 includes a first wing portion 54 extending radially away from the central axis 52 in a first radial direction 60 and a second wing portion 58 extending radially away from the central axis 52 in a second radial direction 56 that is shown oppositely disposed from the first radial direction 60. In other words, the second wing portion 58 is shown angled about 180 degrees from the first wing portion 54. However, it is to be understood that the relative angular orientation between the first wing portion 54 and the second wing portion 58 may be any alternative angle from that shown. As shown, the first wing portion 54 and the second wing portion 58 combine to form a propeller-like member. The propeller wings have clearance to the second component aperture 26 as the protrusion is initially inserted into the receiving feature (FIG. 4). The first wing portion 54 and the second wing portion 58 each have an abutment side 62 that is configured to abut a portion of the second component 14. The abutment side 62 of the first wing portion 54 and/or the second wing portion 58 may have an angled surface (not shown) to facilitate translation along a portion of the second component 14.

Although the retention member 50 is illustrated and described herein as having two wing portions, it is to be appreciated that a single wing portion, such as the first wing portion 54 or the second wing portion 58, may be employed. Although the wing portions are shown as being longer than protrusion diameter 33 it is to be appreciated that the wing portion 54 or 58 may be relatively short with a length less than the diameter of the protrusion 20.

Referring now to FIGS. 2 and 3, a first embodiment of the second component 14 is illustrated. The second surface 21 of the second component 14 includes one or more ramps 64 extending away from the second surface 21 at an angle. The number of ramps may vary and typically corresponds to the number of wing portions of the retention member 50. In the illustrated embodiment, two ramps are included to correspond to the two wing portions of the retention member 50. The angle of the ramp(s) 64 may vary depending on the characteristics of the retention member 50. In particular, the ramp(s) 64 include a ramp surface 68 that angles away from the second surface 21. Additionally, the ramp(s) 64 include a drop-off portion 70 that extends between the ramp surface 68 to the second surface 21 or to a secondary surface in the ramp feature 64.

Reference is now made to FIGS. 4-7, which depict detail of the retention member 50 in various stages of engagement with the ramps 64 for mating the first and second components 12, 14 (FIGS. 4 and 5, pre-engaged; FIG. 6, partially engaged; FIG. 7, fully engaged).

FIG. 4 illustrates the retention member 50 in a configuration corresponding to insertion of the main body 22 of the protrusion 20 into the receiving feature 26. Once the main body 22 is fully inserted into the receiving feature 26, the retention member 50 is disposed in a pre-engaged position with respect to the second component 14, and more particularly with respect to the ramps 64.

FIG. 5 depicts partial rotation of the retention member 50. Specifically, a wing portion of the retention member 50, such as the first wing portion 54, is rotated to begin engaging the ramp 64.

FIG. 6 shows the first wing portion 54 in a position corresponding to further rotation of the retention member 50 in a direction 72. The first wing portion 54 translates along the ramp surface 68. As noted above, the retention member 50 is typically formed of an elastically deformable material, such that elastic deformation of the retention member 50 occurs during translation along the ramp surface 68. However, it is contemplated that the retention member 50 is formed of a semi-rigid material that allows the retention member 50 to be manipulated during rotation along the ramp surface 68.

FIG. 7 shows the retention member 50 in a fully rotated and engaged position relative to the ramps 64. Upon sufficient rotation, the first wing portion 54 and the second wing portion 58 depart ramp 68 to abut face 70 and second surface 21 of the second component 14 once rotated past the drop-off portion 70 of the ramps 64. The drop-off portion 70 prevents the retention member 50 from rotating backwards, thereby “locking” the retention member 50 in place. Such a position facilitates retention of the first component and second components 12, 14 in the second direction 40 and also direction 36. It will be appreciated that the wing portion 58 may drop down and abut a surface that is formed into the ramp 64 and is above surface 21. Such an embodiment may facilitate keeping the wings flexed, thereby providing a greater spring load for retention in direction 40.

It is contemplated that depressions, grooves, or the like are formed in the second surface 21 of the second component 14. Such an embodiment may replace the need for ramps 64, as the wing portions of the retention member 50 are rotated until they are dropped into, or engage, the feature of the second surface 21.

Irrespective of the particular feature (e.g., ramps, depressions) employed to retain the wing portions of the retention member 50, it is to be appreciated that the angle of rotation that the retention member 50 must undergo to achieve the fully engaged position will vary. In particular, although the degree of rotation appears to be about 90 degrees in the illustrated embodiments described above, a range of about 20 degrees to about 90 degrees is considered suitable depending on the location and dimensions of the retaining feature.

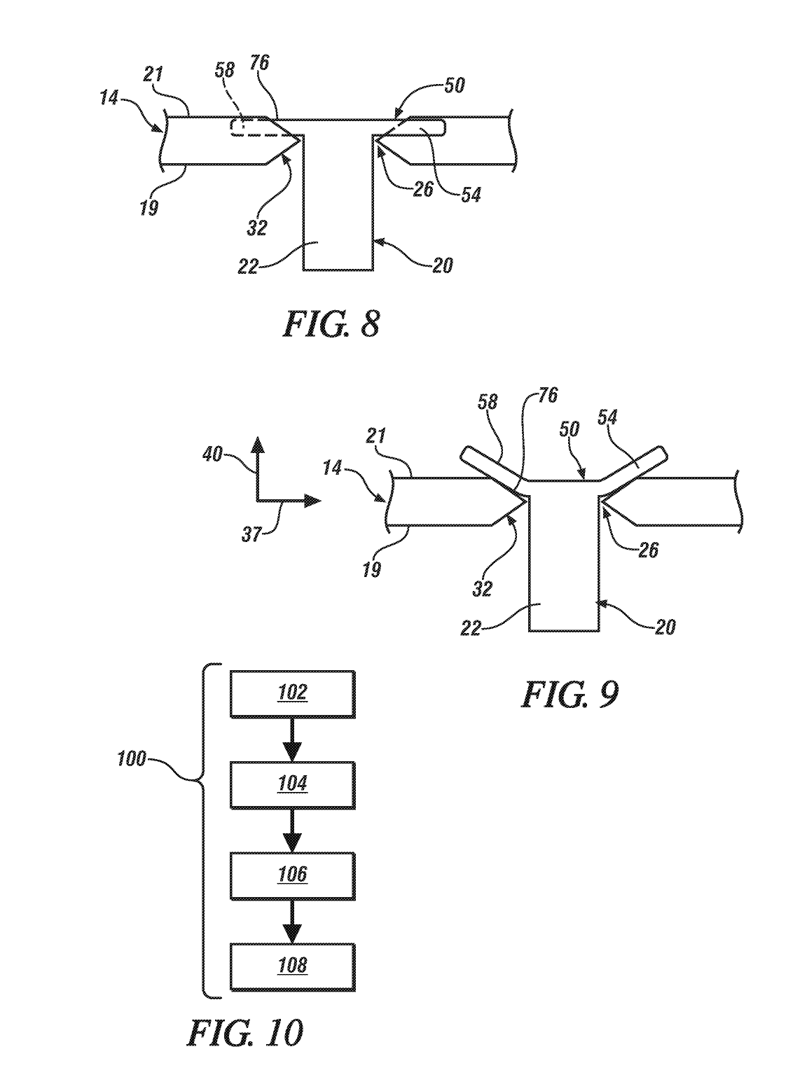

Referring now to FIGS. 8 and 9, another embodiment of the second component 14 is illustrated. Rather than initially abutting the second surface 21 of the second component 14, the wing portions 54, 58 engage an angled region 76 of the aperture wall 32 of the receiving feature 26. As shown, the angled region 76 extends from an intermediate point of the receiving feature 26 to the second surface 21 of the second component 14.

FIG. 8 illustrates a position of the retention member 50 corresponding to insertion of the main body 22 of the protrusion 20 into the receiving feature 26. Once the main body 22 is fully inserted into the receiving feature 26, the retention member 50 is disposed in a pre-engaged position with respect to the second component 14, and more particularly with respect to the angled region 76 of the receiving feature 26.

FIG. 9 shows the retention member 50 in a fully rotated and engaged position relative to the angled region 76. Upon sufficient rotation, the first wing portion 54 and the second wing portion 58 interact with the angled region 76 and, optionally, the second surface 21, to achieve an interference condition with the second component 14. Such a position facilitates retention of the first component 12 in the second direction 40. As noted above, it is to be appreciated that the wing portions 54, 58 may be much shorter than that shown in the illustrated embodiment. Specifically, the wing portion 54, 58 may be configured to ride up the angled regions 76, but not fully to the second surface 21. Such an embodiment may be referred to as a “sub-flush” configuration.

As shown in FIG. 1, at least one standoff extends from either the first surface 18 of the first component 12 or the first surface 19 of the second component 14. The standoff 78 is configured to maintain a space between the first surface 18 and the first surface 19.

A method 100 of assembling matable components is also provided, as illustrated in FIG. 10, and with reference to FIGS. 1-9. The elastic retaining assembly 10, and more specifically the elastically deformable nature of the protrusion 20, has been previously described and specific structural components need not be described in further detail. The method 100 includes inserting 102 the elastically deformable protrusion 20 of the first component 12 into the receiving feature 26 of the second component 14, wherein a contact interference condition between the elastically deformable protrusion 20 and the wall 32 of the receiving feature 26 retains the elastically deformable protrusion 20 in a first direction 37. The method also includes elastically deforming 104 the elastically deformable protrusion 20 upon contacting the wall 32 of the receiving feature 26. The method further includes rotating 106 the elastically deformable protrusion 20 with a first wing portion 54 extending radially away from a central axis of the elastically deformable protrusion 20 and a second wing portion 58 extending radially away from the central axis in a first radial direction, wherein the second wing portion 58 is angled about 180 degrees from the first radial direction. The method yet further includes retaining 108 the first component 12 to the second component 14 in a second direction 40 that is substantially perpendicular to the first direction 37 upon rotating the elastically deformable protrusion 20 into a fully engaged position.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastic retaining assembly for matable components comprising:
a first component having a first surface;
a second component having a first surface and a second surface, the second component configured to be mated with the first component in a fully engaged position;
a receiving feature extending through the second component, the receiving feature defining a wall;
a protrusion operatively coupled to, and extending away from, the first surface, wherein the protrusion is formed of an elastically deformable material and configured to elastically deform upon contact with the wall of the receiving feature, wherein the protrusion retains the first component to the second component in a first direction in the fully engaged position; and
a retention member located at a first end of the protrusion and extending radially from the first end of the protrusion, the retention member formed of the elastically deformable material, wherein the retention member is configured to abut the second surface of the second component and be rotated to retain the first component to the second component in a second direction that is substantially perpendicular to the first direction in the fully engaged position.

2. The elastic retaining assembly of claim 1, wherein the protrusion comprises a solid cylindrical member.

3. The elastic retaining assembly of claim 1, wherein the protrusion comprises a hollow tubular member.

4. The elastic retaining assembly of claim 1, wherein the receiving feature comprises a cutout slot portion extending through the second component from the first surface of the second component to the second surface of the second component.

5. The elastic retaining assembly of claim 1, wherein the retention member comprises a first wing portion extending radially away from a central axis of the protrusion in a first radial direction.

6. The elastic retaining assembly of claim 5, wherein the retention member further comprises a second wing portion extending radially away from the central axis of the protrusion in a second radial direction.

7. The elastic retaining assembly of claim 5, wherein the second surface of the second component comprises at least one ramp, the first wing portion configured to rotate along the ramp into an interference condition in a fully engaged position.

8. The elastic retaining assembly of claim 6, wherein the second surface of the second component comprises a first ramp and a second ramp, the first wing portion configured to rotate along the first ramp and the second wing portion configured to rotate along the second ramp into an interference condition in the fully engaged positions.

9. The elastic retaining assembly of claim 5, further comprising an angled region of the wall of the receiving feature, the angled region located proximate the second surface of the second component, wherein the first wing portion is configured to rotate along the angled region and onto the second surface of the second component into an interference condition.

10. The elastic retaining assembly of claim 1, wherein the retention member is rotated greater than about 20 degrees to achieve the fully engaged condition.

11. The elastic retaining assembly of claim 1, wherein the retention member is rotated at least about 90 degrees to achieve the fully engaged condition.

12. The elastic retaining assembly of claim 1, wherein the protrusion comprises a protrusion width, and wherein a portion of the wall of the receiving feature comprises a wall width that is less than the protrusion width.

13. The elastic retaining assembly of claim 1, further comprising at least one standoff extending from at least one of the first surface of the first component and the first surface of the second component, the at least one standoff configured to maintain a space between the first surface of the first component and the first surface of the second component.

14. The elastic retaining assembly of claim 1, further comprising:
a plurality of protrusions operatively coupled to the first component; and
a plurality of receiving features defined by the second component and configured to receive the plurality of protrusions.

15. The elastic retaining assembly of claim 14, wherein the fully engaged position comprises contact interference between a protrusion perimeter surface of each of the plurality of protrusions and the plurality of receiving features, wherein an amount of deformation of the plurality of protrusions is averaged in aggregate.

16. The elastic retaining assembly of claim 1, wherein the first component and the second component each comprise automotive components.

17. The elastic retaining assembly of claim 16, wherein the first component comprises an interior trim component.

18. A method of assembling matable components comprising:
inserting an elastically deformable protrusion of a first component into a receiving feature of a second component, wherein a contact interference condition between the elastically deformable protrusion and a wall of the receiving feature retains the elastically deformable protrusion in a first direction;
elastically deforming the elastically deformable protrusion upon contacting the wall of the receiving feature;
rotating at least a portion of the elastically deformable protrusion with a first wing portion extending radially away from a central axis of the elastically deformable protrusion and a second wing portion extending radially away from the central axis in a first radial direction, wherein the second wing portion is angled about 180 degrees from the first radial direction; and
retaining the first component to the second component in a second direction that is substantially perpendicular to the first direction upon rotating the elastically deformable protrusion into a fully engaged position.

19. The method of claim 18, wherein rotating the elastically deformable protrusion comprises:
elastically deforming the first wing portion and the second wing portion upon engagement with an angled surface located proximate a surface of the second component; and
rotating the first wing portion and the second wing portion greater than about 20 degrees.

20. The method of claim 18, further comprising elastically averaging the deformation over a plurality of elastically deformable protrusions, wherein upon reaching the fully engaged position of the plurality of elastically deformable protrusions a fitted alignment between the first component and the second component is achieved.
